(19) United States
(12) Patent Application Publication
(10) Pub. No.: US 2013/0024294 A1
(43) Pub. Date: Jan. 24, 2013

(54) METHOD AND SYSTEM FOR GENERATING SOCIAL-CREATED CONTENT BASED ON USER PARTICIPATION

(71) Applicants: Sang Hyun JOO, Daejeon-si (KR); Il Kwon Jeong, Daejeon-si (KR); Bon Ki Koo, Daejeon-si (KR)

(72) Inventors: Sang Hyun JOO, Daejeon-si (KR); Il Kwon Jeong, Daejeon-si (KR); Bon Ki Koo, Daejeon-si (KR)

(73) Assignee: Electronics and Telecommunications Research Institute, Daejeon (KR)

(21) Appl. No.: 13/553,471

(22) Filed: Jul. 19, 2012

(30) Foreign Application Priority Data
Jul. 19, 2011 (KR) 10-2011-0071624
Oct. 7, 2011 (KR) 10-2011-0102324

(51) Int. Cl. G06F 3/01; G06Q 30/02; G06F 15/16

(52) U.S. Cl. 705/14.69; 709/204; 715/751; 705/14.4

(57) ABSTRACT

The present invention relates to a method and system for generating a social-created content (SCC), and more particularly, relates to a method and system for generating and distributing various contents online by users. In particular, according to embodiments of the present invention, it is possible to generate and publish a joint SCC through participation of a plurality of users included in a social community. According to embodiments of the present invention, users of a social community may evaluate a quality of user-created contents (UCCs) uploaded by content suggesters and thus, a system for generating an SCC may generate and publish a high-quality SCC.

### CROSS-REFERENCE TO RELATED APPLICATIONS

This application claims the benefit of Korean Patent Application No. 10-2011-0071624, filed on Jul. 19, 2011, and No. 10-2011-0102324, filed on Oct. 7, 2011 in the Korean Intellectual Property Office, the disclosures of which are incorporated herein by reference.

### BACKGROUND

1. Field of the Invention

The present invention relates to a method and system for generating a social-created content (SCC), and more particularly, to a method and system for generating and distributing various contents online.

2. Description of the Related Art

In general, contents distributed online may be divided into a user-created content (UCC) and a ready made content (RMC).

The UCC may refer to content generated by directly an average person rather than an Internet service provider or a content provider, and may filled with materials and information since the UCC may be generated by various people.

The RMC may refer to content generated by a content provider such as an enterprise, a film company, a broadcasting company, and the like, and may include relatively more technical content when compared to the UCC.

However, the UCC may be indiscriminately generated by a great number of people and thus, may have a poor quality when compared to the RMC. The RMC may be generated by a production intent of a predetermined provider and thus, may include content assiduously generated due to a planned intent or a company policy.

### SUMMARY

An aspect of the present invention provides a method and system for generating a social-created content (SCC) based on a user participation that may generate a joint SCC through a participation of a plurality of users included in a social community.

Another aspect of the present invention provides a method and system for generating an SCC based on a user participation that may enable users of a social community to generate an SCC having high-quality content through an operation of evaluating, by the users of the social community, a quality of a user-created content (UCC) uploaded by content suggesters.

Still another aspect of the present invention provides a method and system for generating an SCC based on a user participation that may evaluate a level of contribution made by users that participate in a generation of an SCC, and disburse a profit obtained from the SCC to the users based on the level of contribution.

According to an aspect of the present invention, there is provided a method of generating an SCC, the method including obtaining a plurality of UCCs based on inputs from content suggesters, evaluating a quality of the plurality of UCCs based on a response from at least one participant among users of a social community, and generating at least one SCC from the plurality of UCCs based on the evaluated quality.

The generating may include selecting at least two UCCs from the plurality of UCCs based on the evaluated quality, and generating an SCC including the at least two selected UCCs.

The generating may include determining ranks of the plurality of UCCs matching the evaluated quality based on the response from the at least one participant, and generating the at least one SCC from the plurality of UCCs based on the determined ranks.

The evaluating may include generating a voting interface for receiving a vote for at least one of a recommendation, an agreement, a disuse, and a modification, providing the generated voting interface to the at least one participant among the users of the social community, and evaluating a quality of each of the plurality of UCCs based on a result of receiving a vote via the provided voting interface.

The evaluating of the quality of each of the plurality of UCCs based on the result of receiving a vote may include detecting an unjust vote based on unique information of the at least one participant.

The method may further include evaluating a level of contribution made by the at least one participant and the content suggesters to the at least one SCC.

The method may further include obtaining confirmations from the at least one participant and the content suggesters as to the level of contribution, and reevaluating the level of contribution when obtaining of the confirmations fails.

The method may further include determining a disbursement rate of a profit obtained from the at least one SCC based on the level of contribution made by the at least one participant and the content suggesters to the at least one SCC.

The method may further include verifying that correction of one of the plurality of UCCs is required, and requesting data correction of the one of the plurality of UCCs from at least one of a pre-designated participant among the users of the social community, a participant having a rating greater than or equal to a predetermined value, the content suggesters, and a participant requiring the correction of the one of the plurality of UCCs.

The method may further include verifying that correction of one of the plurality of UCCs is required, generating another voting interface for voting on an object to be corrected, among at least one of a multimedia, text, an image, a subject, a word, a typographical error, and a design of the one of the plurality of UCCs requiring correction, providing the other generated voting interface to the at least one participant, and requesting correction of an object to be corrected selected through the other voting interface from at least one of a pre-designated participant among the users of the social community, a participant having a rating greater than or equal to a predetermined value, the content suggesters, and a participant requiring the correction of the one of the plurality of UCCs.

The method may further include generating an opinion for demanding at least one of a publication and a disuse of at least one UCC based on the response from the at least one participant, providing, to a participant other than a participant generating the opinion in the social community, a voting interface for receiving an input of an agreement and a disagreement in response to the generated opinion, and determining whether to publish the at least one UCC as an SCC based on a result of receiving an input through the voting interface.

The method may further include generating an opinion on selecting an object to be corrected for the at least one UCC based on the response from the at least one participant, providing, to a participant other than a participant generating the opinion in the social community, a voting interface for receiving an input of an agreement and a disagreement in response to the generated opinion, and determining whether to correct the object to be corrected for the at least one UCC based on a result of receiving an input through the voting interface, wherein the object to be corrected corresponds to at least one of a multimedia, text, an image, a subject, a word, a typographical error, and a design of the at least one UCC.

The method may further include displaying the at least one generated SCC and at least one advertisement in response to a request for provision of content via an external communication network, and disbursing an advertisement rate, occurring in response to the displaying, to the content suggesters and the at least one participant.

The method may further include recording inputs from the content suggesters and the at least one participant, and setting a level of contribution to the at least one SCC based on the recorded inputs, wherein the disbursing comprises paying the advertisement rate to the content suggesters and the at least one participant based on the set level of contribution.

The setting of the level of contribution may include applying, based on the recorded inputs, a greater level of contribution compared to a contribution level of other people, to one of a content suggester generating a UCC and a participant generating an opinion on a correction or correcting data.

According to another aspect of the present invention, there is provided a content generating server, including a UCC obtaining unit to obtain a plurality of UCCs based on inputs from content suggesters, a quality evaluation unit to evaluate a quality of the plurality of UCCs based on a response from at least one participant among users of a social community, and an SCC generator to generate at least one SCC from the plurality of UCCs based on the evaluated quality.

According to still another aspect of the present invention, there is provided a system for generating an SCC capable of performing data communication with a device for generating a plurality of UCCs, by content suggesters, the system including a content generating server to obtain a plurality of UCCs based on inputs from the content suggesters, evaluate a quality of the plurality of UCCs based on a response from at least one participant among users of a social community, and generate at least one SCC from the plurality of UCCs based on the evaluated quality.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an operation of generating content in a method of generating a social-created content (SCC) according to embodiments of the present invention;

FIG. 2 is a diagram illustrating a system for performing a method of generating an SCC according to embodiments of the present invention;

FIG. 3 is a diagram illustrating a configuration of a server performing a method of generating an SCC according to embodiments of the present invention; and

FIGS. 4 through 6 are flowcharts illustrating a method of generating an SCC according to embodiments of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

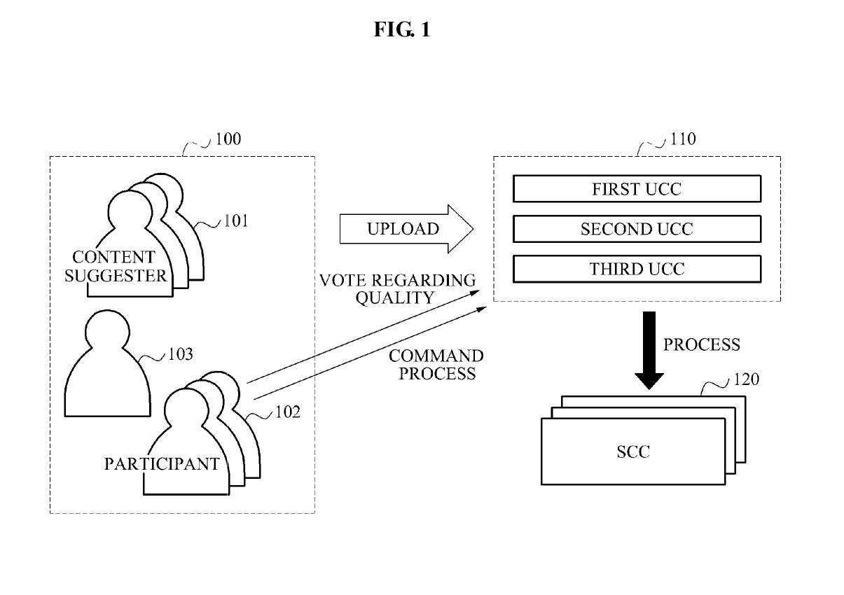

FIG. 1 is a diagram illustrating an operation of generating content in a method of generating a social-created content (SCC) according to embodiments of the present invention.

Referring to FIG. 1, users of a social community 100 may correspond to at least one of a content suggester 101 generating a user-created content (UCC), a participant 102 participating in a generation of an SCC 120 through a quality evaluation of the generated UCC, and a non-participant 103.

Tasks for the users may be determined through inputting a selection in real time, and may be predetermined through being provided with a predetermined right or level from a system. Each user may correspond to a single task, and may correspond to a plurality of tasks, as necessary. For example, a user may correspond to both of the content suggester 101 and the participant 102.

The content suggester 101 may generate a UCC by manipulating a terminal of the content suggester 101 (hereinafter, referred to as a user terminal), and upload the UCC into a communication network. Here, UCCs 110 uploaded by the content suggester 101 may exist online in a form of a first UCC, a second UCC, a third UCC, and the like.

The participant 102 among the users of the social community 100 may conduct a vote regarding a quality evaluation for the UCCs 110, and command a process on the UCCs 110 based on a result of conducting the vote.

As a result of the process, the SCC 120 may be generated from the UCCs 110. For convenience of description, FIG. 1 illustrates that the users correspond to a single social community. However, the users may correspond to a plurality of social communities. For example, the plurality of social communities may be classified into a first social community including a content suggester and a second social community including a participant.

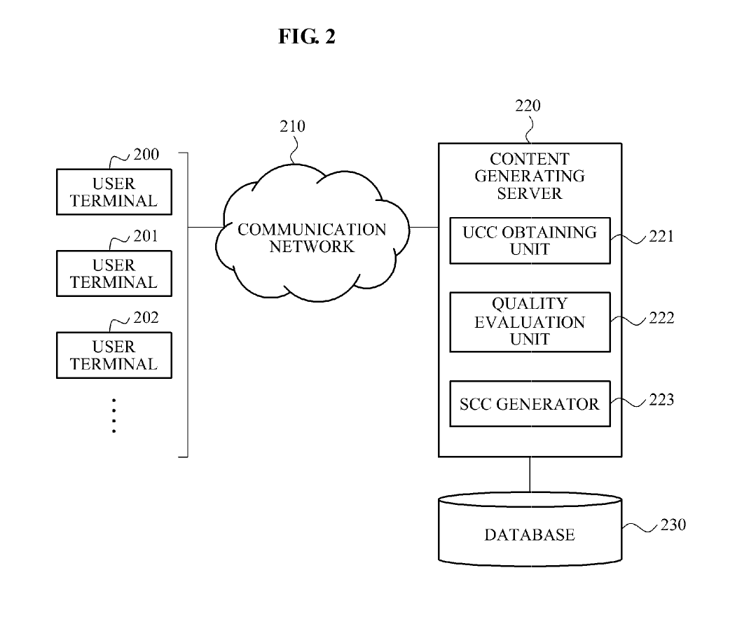

FIG. 2 is a diagram illustrating a system for performing a method of generating an SCC according to embodiments of the present invention.

Referring to FIG. 2, a plurality of user terminals, for example, user terminals 200 through 202 may operate in conjunction with a content generating server 220 through a communication network 210, and upload, into the content generating server 220, a UCC generated by a user corresponding to a content suggester.

The content generating server 220 may obtain UCCs uploaded from the user terminals 200 through 202 through the communication network 210, evaluate a quality of each of the obtained UCCs based on a response from a participant of a social community, and generate an SCC from the obtained UCCs based on a result of evaluating the quality.

The content generating server 220 may include a UCC obtaining unit 221, a quality evaluation unit 222, and an SCC generator 223.

The UCC obtaining unit 221 may obtain UCCs uploaded from the user terminals 200 through 202, and store the obtained UCCs in a database 230.

In particular, the UCC obtaining unit 221 may receive an upload of UCCs directly from the user terminals 200 through 202, or may collect UCCs previously uploaded via another server.

The quality evaluation unit 222 may evaluate a quality of each of the obtained UCCs based on a response from a participant of a social community.

The quality evaluation unit 222 may display, to users of the social community, UCCs obtained by the UCC obtaining unit 221, and generate a voting interface for evaluating a quality of each of the UCCs based on a response from at least one participant among the users.

Here, the users may refer to an entire or a portion of users within at least one social community, and the at least one participant may refer to users, among the users, inputting a selection via the voting interface.

The quality evaluation unit 222 may generate a voting interface so that a user of a social community may conduct a vote to select at least one of recommendation, agreement, disuse, and modification, based on a selection of a participant that is input through the voting interface, and evaluate a quality of each of the UCCs based on a result of conducting the vote.

The quality evaluation unit 222 may detect an unjust vote based on unique information of a participant in an operation of conducting the vote. Here, the unique information may include at least one of an identification (ID) of the participant, an Internet protocol (IP) address, and session information. That is, the quality evaluation unit 222 may detect an unjust vote of a participant based on an ID of the participant, an IP address, or session information, and exclude from the result of conducting the vote, an input of a selection from which an unjust vote is detected.

The SCC generator 223 may generate at least one SCC from the obtained UCCs based on a result of the quality evaluation unit 222 evaluating a quality of the at least one SCC, and store the at least one generated SCC in the database 230.

In particular, the SCC generator 223 may select a single UCC or at least two UCCs from the UCCs based on a result of the quality evaluation unit 222 evaluating a quality of the at least two UCCs. The SCC generator 223 may generate a single SCC using the selected single UCC, and may generate a unified SCC or an individual SCC using the at least two selected UCCs.

The SCC generator 223 may rank each of the UCCs based on a result of the quality evaluation unit 222 evaluating a quality of the UCCs, and select, as an object used to generate an SCC, UCCs corresponding to a rank greater than or equal to a predetermined rank based on the ranked UCCs.

The content generating server 220 may estimate a level of contribution made by a participant or content suggesters to the SCC generated based on a result of (*a participant evaluating a quality of the SCC? evaluating a quality of a participant.

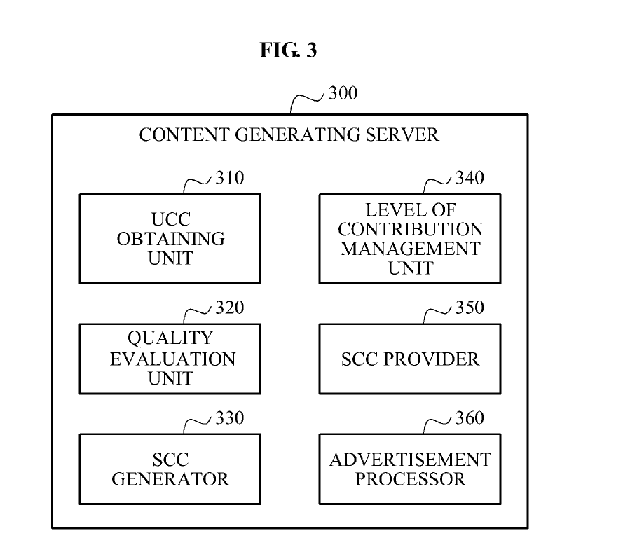

FIG. 3 is a diagram illustrating a configuration of a server performing a method of generating an SCC according to embodiments of the present invention.

Referring to FIG. 3, a content generating server 300 may include a UCC obtaining unit 310, a quality evaluation unit 320, an SCC generator 330, and a level of contribution management unit 340.

Here, the UCC obtaining unit 310, the quality evaluation unit 320, and the SCC generator 330 (*provided may be similar to? may be provided similar to corresponding components in the content generating server 220 illustrated in FIG. 2, that is, the UCC obtaining unit 221, the quality evaluation unit 222, and the SCC generator 223. However, the quality evaluation unit 320 may record, in a database, selections input via a voting interface, in real time.

The level of contribution management unit 340 may evaluate a level of contribution, to an SCC generated by the SCC generator 330, made by a content suggester or a participant participating in an operation of generating the SCC.

In particular, the level of contribution management unit 340 may estimate a level of contribution made by the content suggester based on whether each of the UCCs generated by the content suggester is used to generate the SCC, and estimate a level of contribution made by the participant based on a record of the quality evaluation unit 320. Here, the level of contribution made by the participant may correspond to a predetermined value, and may correspond to a number of selection inputs recorded by the quality evaluation unit 320, or a value adjusted according to a total number of participants.

The level of contribution management unit 340 may receive an input of a confirmation from the participant or the content suggester as to the estimated level of contribution, and reevaluate the level of contribution made by the participant or the content suggester when obtaining of the confirmation fails based on whether the confirmation is input. In this instance, the level of contribution management unit 340 may further perform an operation of displaying the estimated level of contribution to the participant or the content suggester, an operation of receiving the input of the confirmation from the participant, operation of receiving the input of the confirmation from the content suggester, and an operation of requesting a reevaluation on the level of contribution.

The level of contribution management unit 340 may determine a disbursement rate of a profit obtained from at least one SCC for each of the participant and the content suggester. In particular, the level of contribution management unit 340 may determine the disbursement rate based on the level of contribution and a number of participants and content suggesters and thus, the participant and the content suggester may receive a share of the profit in return for participating in generation of the at least one SCC.

The content generating server 300 may further include an SCC provider 350.

The SCC provider 350 may be constructed as a component of the content generating server 300, and be included in a device having the SCC generator 330 as illustrated in FIG. 3. The SCC provider 350 may also be provided as a component of a separate server other than the content generating server 300.

The SCC provider 350 may distribute, online, an SCC generated by the SCC generator 330, and stored in a database. That is, in response to a request, for example, a search keyword, and the like input through a communication network, the SCC provider 350 may transmit an SCC generated by the SCC generator as an SCC stored in the database to a user terminal inputting the request.

Here, a target SCC transmitted to the user terminal may be transmitted along with advertisement data stored in advance. In this instance, the content generating server 300 may further include an advertisement processor 360, and the database may store the advertisement data in advance.

The advertisement processor 360 may determine a target advertisement corresponding to an advertisement to be displayed along with the target SCC in response to a request from the SCC provider 350, and deliver, to the SCC provider 350, advertisement data associated with the determined target advertisement. In response to the advertisement data being delivered, the advertisement processor 360 may disburse an advertisement rate, occurring in response to the advertisement data being displayed, to the content suggester and the participant.

When a level of contribution made by the content suggester and the participant to the target SCC is set by the level of contribution management unit 340, the advertisement processor 360 may divide, based on the level of contribution, the advertisement rate to be disbursed to the content suggester and the participant. The advertisement processor 360 may divide and disburse the advertisement rate to the content suggester and the participant participating in generation of the target SCC based on the level of contribution set by the level of contribution management unit 340.

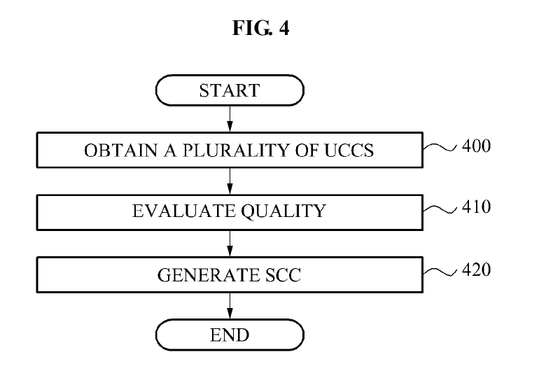

FIGS. 4 through 6 are flowcharts illustrating a method of generating an SCC according to embodiments of the present invention.

Referring to FIG. 4, in operation 400, a content generating server performing the method of generating an SCC may obtain a plurality of UCCs generated based on inputs from content suggesters.

In operation 410, the content generating server may deliver, to users of a social community, the plurality of obtained UCCs, and evaluate a quality of each of the UCCs based on a response from at least one participant among the users.

In operation 420, the content generating server may generate at least one SCC from the UCCs based on the evaluated quality.

Here, the content generating server may select at least two UCCs from the plurality of obtained UCCs based on the evaluated quality, and generate an SCC corresponding to each of the at least two UCCs or a single unified SCC including each of the at least two UCCs.

The content generating server may rank each of the UCCs based on the evaluated quality, and select a UCC to generate the SCC based on the ranked UCCs.

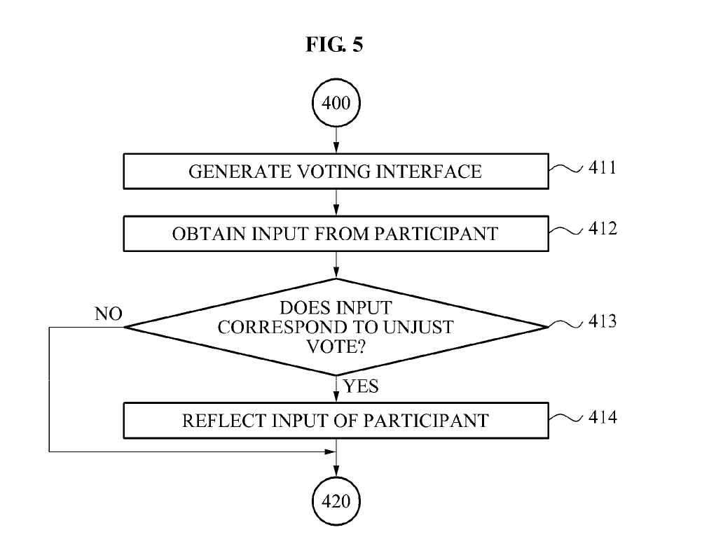

The content generating server may evaluate a quality of a UCC by receiving votes from participants. In this instance, the content generating server may further perform operations illustrated in FIG. 5.

In operation 411, the content generating server may generate a voting interface for receiving, from a participant, a vote for at least one of recommendation, agreement, disuse, and modification, and provide the generated voting interface to at least one participant or users of a social community.

In operation 412, the content generating server may obtain a selection input by the participant via the voting interface.

In operation 413 the content generating server may detect an unjust vote based on unique information of the participant voting, and evaluate a quality of each of the UCCs based on the selection input by a participant from which an unjust vote fails to be detected in operation 414.

A participant may request data correction of the UCCs via the voting interface.

In this instance, in response to a request for the data correction being made, the content generating server may request the data correction from at least one of a pre-designated participant having a predetermined right, a participant having a rating greater than or equal to a predetermined value and a content suggester of the UCC, and perform the data correction.

A participant may suggest a target for data correction in the UCC.

In particular, in response to a request for the data correction, the content generating server may generate another voting interface for voting on an object to be corrected, among at least one of a multimedia, text, an image, a subject, a word, a typographical error, and a design of the UCC.

The content generating server may provide the other generated voting interface to the participant, and receive an input of a selection input by the participant, thereby selecting a target for data correction in the UCC, and requesting correction of the target for data correction from at least one of a pre-designated participant having a predetermined right, a participant having a rating greater than or equal to a predetermined value, a content suggester of the UCC, and a participant requesting the correction.

In response to (*a vote/an input? from at least one participant, the content generating server may select an object to be corrected for the UCC, and gather opinions agreeing or disagreeing as to correction of the selected object.

In this instance, the content generating server may suggest an object to be corrected for the UCC, and generate a voting interface for receiving an input of an agreement and a disagreement on the suggested object to be corrected. The content generating server may provide, to participants other than a participant suggesting the object to be corrected, the generated voting interface for receiving an input of an agreement and a disagreement, and determine whether to correct the object based on opinions of the other participants.

The object to be corrected may correspond to at least one of a multimedia, text, an image, a subject, a word, a typographical error, and a design of at least one UCC.

A participant may demand publication or disuse of a target UCC, and the other participants may agree or disagree with via the voting interface.

In particular, the content generating server may generate an opinion for demanding a publication or a disuse of a target UCC based on a selection input by a participant, and provide other participants of the social community with a voting interface for receiving an input of an agreement and a disagreement as to the generated opinion. The content generating server may determine whether to publish the target UCC as an SCC based on a result of receiving an input of an agreement and a disagreement via the voting interface.

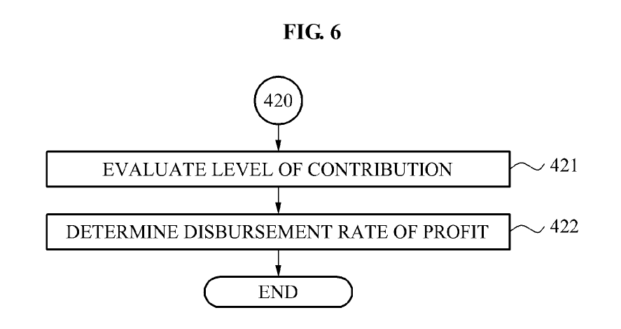

The content generating server may estimate a level of contribution made by a participant or content suggesters to at least one SCC. In this instance, the content generating server may perform operations illustrated in FIG. 6.

In operation 421, the content generating server may evaluate a level of contribution, predetermined or calculated in real time, made by a participant participating in an operation of generating an SCC, and content suggesters of UCCs used to generate the SCC. The level of contribution calculated in real time may vary depending on a number of the content suggesters and participants and a record of the content generating server.

The content generating server may transmit the evaluated level of contribution to the participant or the content suggesters, and enable the participant or the content suggesters to verify a level of contribution made by the participant, the content suggesters, or another person. When obtaining confirmation from the participant or the content suggesters fails, the content generating server may reevaluate a level of contribution made by the participant, the content suggesters, and another person.

In operation 422, the content generating server may determine a disbursement rate of a profit obtained from the SCC for each of the participant and the content suggesters based on the level of contribution evaluated in operation 421.

The content generating server may link the SCC to an advertisement service. A function for linking the SCC may be performed by the content generating server directly, or be performed by a separate advertisement server.

When the function for linking the SCC is performed directly by the content generating server, the content generating server may display the SCC and at least one advertisement in response to a request for provision of content via an external communication network. In this instance, the content generating server may disburse an advertisement rate, occurring in response to the displaying, to the content suggesters and the participant.

The content generating server may disburse an advertisement rate based on a level of contribution made by a user.

For example, the content generating server may record inputs from at least one participant and a content suggester participating in a generation of an SCC, and apply, to each of the at least one participant and the content suggester, a level of contribution to the SCC. The content generating server may disburse an advertisement rate, occurring from an advertisement displayed along with the SCC, to the content suggester and the at least one participant based on the level of contribution.

When setting the level of contribution, the content generating server may apply a greater level of contribution compared to a contribution level of other people, to at least one of a content suggester generating a UCC used for generating the SCC and a participant generating an opinion on a correction or correcting data.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of generating a social-created content (SCC), the method comprising:
obtaining a plurality of user-created contents (UCCs) based on inputs from content suggesters;
evaluating a quality of the plurality of UCCs based on a response from at least one participant among users of a social community; and
generating at least one SCC from the plurality of UCCs based on the evaluated quality.

2. The method of claim 1, wherein the generating comprises:
selecting at least two UCCs from the plurality of UCCs based on the evaluated quality; and
generating an SCC including the at least two selected UCCs.

3. The method of claim 1, wherein the generating comprises:
determining ranks of the plurality of UCCs matching the evaluated quality based on the response from the at least one participant; and
generating the at least one SCC from the plurality of UCCs based on the determined ranks.

4. The method of claim 1, wherein the evaluating comprises:
generating a voting interface for receiving a vote for at least one of a recommendation, an agreement, a disuse, and a modification;
providing the generated voting interface to the at least one participant among the users of the social community; and
evaluating a quality of each of the plurality of UCCs based on a result of receiving a vote via the provided voting interface.

5. The method of claim 4, wherein the evaluating of the quality of each of the plurality of UCCs based on the result of receiving a vote comprises:
detecting an unjust vote based on unique information of the at least one participant.

6. The method of claim 1, further comprising:
evaluating a level of contribution made by the at least one participant and the content suggesters to the at least one SCC.

7. The method of claim 6, further comprising:
obtaining confirmations from the at least one participant and the content suggesters as to the level of contribution; and
reevaluating the level of contribution when obtaining of the confirmations fails.

8. The method of claim 6, further comprising:
determining a disbursement rate of a profit obtained from the at least one SCC based on the level of contribution made by the at least one participant and the content suggesters to the at least one SCC.

9. The method of claim 4, further comprising:
verifying that correction of one of the plurality of UCCs is required; and
requesting data correction of the one of the plurality of UCCs from at least one of a pre-designated participant among the users of the social community, a participant having a rating greater than or equal to a predetermined value, the content suggesters, and a participant requiring the correction of the one of the plurality of UCCs.

10. The method of claim 4, further comprising:
verifying that correction of one of the plurality of UCCs is required;
generating another voting interface for voting on an object to be corrected, among at least one of a multimedia, text, an image, a subject, a word, a typographical error, and a design of the one of the plurality of UCCs requiring correction;
providing the other generated voting interface to the at least one participant; and
requesting correction of an object to be corrected selected through the other voting interface from at least one of a pre-designated participant among the users of the social community, a participant having a rating greater than or equal to a predetermined value, the content suggesters, and a participant requiring the correction of the one of the plurality of UCCs.

11. The method of claim 1, further comprising:
generating an opinion for demanding at least one of a publication and a disuse of at least one UCC based on the response from the at least one participant;
providing, to a participant other than a participant generating the opinion in the social community, a voting interface for receiving an input of an agreement and a disagreement in response to the generated opinion; and
determining whether to publish the at least one UCC as an SCC based on a result of receiving an input through the voting interface.

12. The method of claim 1, further comprising:
generating an opinion on selecting an object to be corrected for the at least one UCC based on the response from the at least one participant;
providing, to a participant other than a participant generating the opinion in the social community, a voting interface for receiving an input of an agreement and a disagreement in response to the generated opinion; and
determining whether to correct the object to be corrected for the at least one UCC based on a result of result of receiving an input through the voting interface,
wherein the object to be corrected corresponds to at least one of a multimedia, text, an image, a subject, a word, a typographical error, and a design of the at least one UCC.

13. The method of claim 1, further comprising:
displaying the at least one generated SCC and at least one advertisement in response to a request for provision of content via an external communication network; and
disbursing an advertisement rate, occurring in response to the displaying, to the content suggesters and the at least one participant.

14. The method of claim 13, further comprising:
recording inputs from the content suggesters and the at least one participant, and setting a level of contribution to the at least one SCC based on the recorded inputs,
wherein the disbursing comprises paying the advertisement rate to the content suggesters and the at least one participant based on the set level of contribution.

15. The method of claim 14, wherein the setting of the level of contribution comprises applying, based on the recorded inputs, a greater level of contribution compared to a contribution level of other people, to one of a content suggester generating a UCC and a participant generating an opinion on a correction or correcting data.

16. A content generating server, comprising:
a user-created content (UCC) obtaining unit to obtain a plurality of UCCs based on inputs from content suggesters;
a quality evaluation unit to evaluate a quality of the plurality of UCCs based on a response from at least one participant among users of a social community; and
a social-created content (SCC) generator to generate at least one SCC from the plurality of UCCs based on the evaluated quality.

17. A system for generating a social-created content (SCC) capable of performing data communication with a device for generating, by content suggesters, a plurality of user-created contents (UCCs), the system comprising:
a content generating server to obtain a plurality of UCCs based on inputs from the content suggesters, evaluate a quality of the plurality of UCCs based on a response from at least one participant among users of a social community, and generate at least one SCC from the plurality of UCCs based on the evaluated quality.
